(19) United States
(12) Patent Application Publication
(10) Pub. No.: US 2022/0046184 A1
(43) Pub. Date: Feb. 10, 2022

(54) VIDEO CAMERA SYSTEM

(71) Applicant: DIGILIFE TECHNOLOGIES CO., LTD., Taipei City (TW)

(72) Inventor: CHEN-PING YANG, Taipei City (TW)

(21) Appl. No.: 16/986,293

(22) Filed: Aug. 6, 2020

(51) Int. Cl. H04N 5/268; H04N 5/232; H04N 5/247

(52) U.S. Cl. CPC H04N 5/268; H04N 5/247; H04N 5/23206

(57) ABSTRACT

A video camera system includes a secondary image generation module and a primary image generation module. The primary image generation module includes a primary imaging unit and a processing unit. The primary imaging unit generates a primary image signal. The processing unit receives the primary image signal and generates a primary digital image signal accordingly. The processing unit receives a secondary digital image signal generated by a secondary image generation module and combines the primary digital image signal and the secondary digital image signal to form a single streaming of multiple-angle image signals. The processing unit is electrically connected to a single signal line for sending the multiple-angle image signals to an external electronic device.

### BACKGROUND OF THE INVENTION

### 1. Field of the Invention

The present disclosure relates to video camera systems, and in particular to a video camera system capable of taking images from multiple angles.

### 2. Description of the Related Art

Webcams shoot and send videos and fall within two categories: video cameras connected to electronic devices, such as computers, and webcams dedicated to security surveillance.

Video cameras are widely used in video conferencing and video chats. Exchange of frames and audios occurs instantly between geographically separated user by bidirectional, instant transmission technology, thereby rendering video cameras increasingly prevalent.

Owing to the development of audiovisual platforms, an increasing number of people (i.e., live-streaming hosts) perform live streaming with handy image capturing devices, such as video cameras, to interact with the audience on the audiovisual platforms. To enhance the audience's watching experience, the live-streaming hosts display multiple frames from different angles while the living streaming is taking place.

Conventionally, live-streaming frames taken from different angles are displayed with multiple image capturing devices. The multiple image capturing devices fetch image frames taken from different angles, respectively, and are connected to electronic devices, such as computers, with signal lines, respectively, to send captured images to the electronic devices for image synthesis. However, multiple image capturing devices and the required signal lines take up space. Furthermore, conventional electronic devices do not come with a sufficient number of ports to undergo signal transmission. As a result, image taking is difficult.

### BRIEF SUMMARY OF THE INVENTION

An objective of the present disclosure is to provide a video camera system comprising a primary image generation module and a secondary image generation module and thus is capable of generating a plurality of image signals simultaneously before editing and recombining the plurality of image signals to form a single streaming of multiple-angle image signals, so as to transmit the multiple-angle image signals through one single signal line, thereby enhancing ease of use.

To achieve at least the above objective, the present disclosure provides a video camera system comprising: a secondary image generation module for capturing a secondary image and generating a secondary digital image signal; and a primary image generation module electrically connected to the secondary image generation module by a first signal line and adapted to capture a primary image, generate a primary digital image signal, receive the secondary digital image signal, output multiple-angle image signals including the primary digital image signal and the secondary digital image signal, and be electrically connected to a single second signal line for sending the multiple-angle image signals to an external electronic device; wherein the primary image generation module comprises: a primary imaging unit for capturing the primary image and generating a primary image signal; and a processing unit electrically connected to the primary imaging unit and adapted to receive the primary image signal, generate the primary digital image signal accordingly, and generate the multiple-angle image signals according to the primary digital image signal and the secondary digital image signal; wherein the secondary image generation module comprises: a secondary imaging unit for capturing the secondary image and generating a secondary image signal; and an image processing unit disposed between the secondary imaging unit and the processing unit, electrically connected to the secondary imaging unit and the processing unit, and adapted to receive the secondary image signal, generate the secondary digital image signal accordingly, and send the secondary image signal to the processing unit.

Therefore, the video camera system is capable of capturing a plurality of images simultaneously, and a processing unit of the primary image generation module combines a plurality of digital image signals to form a single streaming of multiple-angle image signals; thus, the video camera system can send a plurality of frames to an external electronic device through one single signal line, so as to enhance ease of use.

### BRIEF DESCRIPTION OF THE DRAWINGS

FIG. 1 is a block diagram of a video camera system and its application according to an embodiment of the present disclosure.

FIG. 2 is a schematic view of application of the video camera system according to the embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

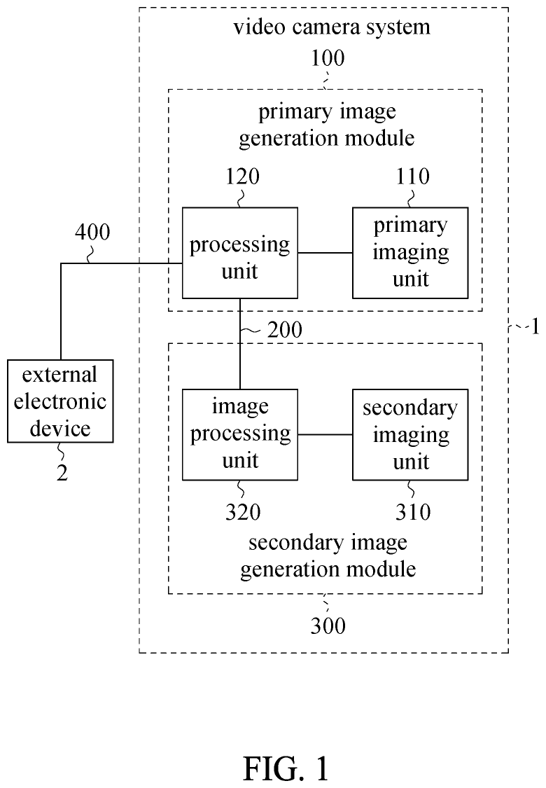

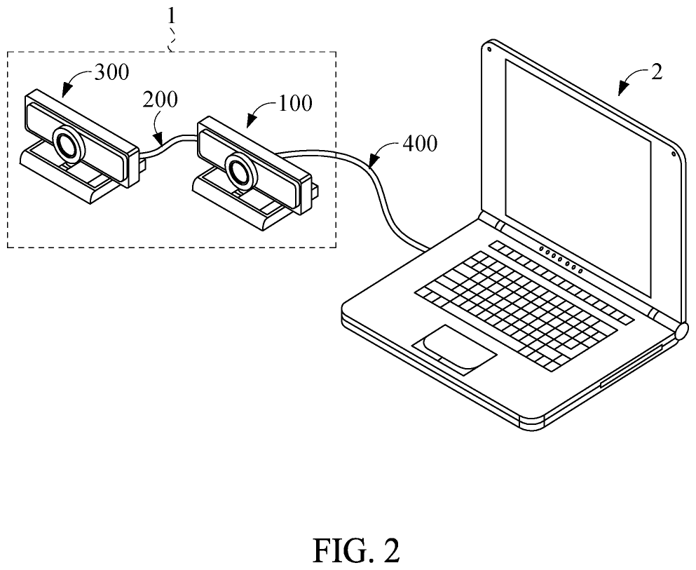

A video camera system is provided according to a preferred embodiment of the present disclosure. Referring to FIG. 1 and FIG. 2, a video camera system 1 comprises a primary image generation module 100 and a secondary image generation module 300. The primary image generation module 100 and the image generation module 300 are electrically connected by a first signal line 200.

The secondary image generation module 300 captures a secondary image, generates a secondary digital image signal, and sends the secondary digital image signal to the primary image generation module 100.

The primary image generation module 100 captures a primary image, generates a primary digital image signal, receives the secondary digital image signal, combines the primary digital image signal and the received secondary digital image signal to form a single streaming of multiple-angle image signals, and sends the multiple-angle image signals to an external electronic device 2 through a single second signal line 400.

The secondary image generation module 300 further comprises a secondary imaging unit 310 and an image processing unit 320. The secondary imaging unit 310 captures the secondary image and generates a secondary image signal. The image processing unit 320 is disposed between the secondary imaging unit 310 and the primary image generation module 100, electrically connected to the secondary imaging unit 310 and the primary image generation module 100, and adapted to receive the secondary image signal, generate the secondary digital image signal accordingly, and send the secondary digital image signal to the primary image generation module 100.

The primary image generation module 100 further comprises a primary imaging unit 110 and a processing unit 120. The primary imaging unit 110 captures the primary image and generates a primary image signal. The processing unit 120 is electrically connected to the primary imaging unit 110 and the image processing unit 320. The processing unit 120 receives the primary image signal, generates the primary digital image signal accordingly, receives the secondary digital image signal from the image processing unit 320, and combines the primary digital image signal and the secondary digital image signal to form a single streaming of the multiple-angle image signals, so as to send the multiple-angle image signals to the external electronic device 2 through the second signal line 400.

In an embodiment, the processing unit 120 receives an external mode signal to determine whether to generate the multiple-angle image signals.

In an embodiment, the processing unit 120 determines the display ratio of the primary digital image signal to the secondary digital image signal when displayed on the external electronic device 2 according to the mode signal and generates the multiple-angle image signals accordingly. For example, according to the mode signal, the display ratio of the primary digital image signal to the secondary digital image signal is 50:50, 70:30, 30:70, 100:0, or 0:100, but the present disclosure is not limited thereto.

In an embodiment, the mode signal is generated by the primary image generation module 100 and sent to the processing unit 120.

In an embodiment, the primary image generation module 100 and the secondary image generation module 300 are each a video camera, but the present disclosure is not limited thereto.

In an embodiment, the primary imaging unit 110 and the secondary imaging unit 310 are image sensing modules in a video camera.

In an embodiment, the secondary imaging unit 310 and the primary imaging unit 110 differ in the angle from which they take images, and thus the secondary image differs from the primary image in terms of image contents, but the present disclosure is not limited thereto.

In an embodiment, the image processing unit 320 is an image processor, but the present disclosure is not limited thereto.

In an embodiment, the processing unit 120 is a digital circuit which comprises a digital signal processor, but the present disclosure is not limited thereto.

In an embodiment, the first signal line 200 and the second signal line 400 are each a transmission line compliant with universal serial bus (USB) protocol, but the present disclosure is not limited thereto.

In an embodiment, the external electronic device 2 is, for example, an electronic device, such as laptop, tablet, PC or smartphone, but the present disclosure is not limited thereto.

Therefore, when performing live streaming or shooting videos, users, for example, live-streaming hosts, can take images at different angles/positions with the video camera system 1 of the present disclosure, send a plurality of digital image signals characterized by different image-taking angles/positions to the external electronic device 2 through one single signal line, need not connect the external electronic device 2 to multiple self-contained image capturing devices and the corresponding signal transmission lines, and need not have access to any ports otherwise required for signal transmission. In short, the video camera system 1 of the present disclosure is effective in fetching captured images with one single signal line and any existing port of the external electronic device 2 easily and quickly, so as to enhance ease of use effectively.

The video camera system 1 of the present disclosure is capable of taking a plurality of images (primary images and secondary images) simultaneously, and a processing unit of the primary image generation module combines a plurality of digital image signals to form a single streaming of the multiple-angle image signals; thus, the video camera system of the present disclosure can send a plurality of separately-captured frames to an external electronic device through one single signal line. Therefore, users not only effect image signal transmission with one single signal line but also display or edit a plurality of received image frames on the external electronic device 2 freely, so as to enhance the ease of use of a video camera device.

While the present disclosure has been described by means of specific embodiments, numerous modifications and variations could be made thereto by those skilled in the art without departing from the scope and spirit of the present disclosure set forth in the claims.

What is claimed is:

1. A video camera system, comprising:
a secondary image generation module for capturing a secondary image and generating a secondary digital image signal; and
a primary image generation module electrically connected to the secondary image generation module by a first signal line and adapted to capture a primary image, generate a primary digital image signal, receive the secondary digital image signal, output multiple-angle image signals including the primary digital image signal and the secondary digital image signal, and be electrically connected to a single second signal line for sending the multiple-angle image signals to an external electronic device;
wherein the primary image generation module comprises:
a primary imaging unit for capturing the primary image and generating a primary image signal; and
a processing unit electrically connected to the primary imaging unit and adapted to receive the primary image signal, generate the primary digital image signal accordingly, and generate the multiple-angle image signals according to the primary digital image signal and the secondary digital image signal;
wherein the secondary image generation module comprises:
a secondary imaging unit for capturing the secondary image and generating a secondary image signal; and
an image processing unit disposed between the secondary imaging unit and the processing unit, electrically connected to the secondary imaging unit and the processing unit, and adapted to receive the secondary image signal, generate the secondary digital image signal accordingly, and send the secondary image signal to the processing unit.

2. The video camera system of claim 1, wherein the primary image generation module and the secondary image generation module are video camera devices.

3. The video camera system of claim 1, wherein the secondary imaging unit and the primary imaging unit differ in an image-taking angle, and thus the secondary image differs from the primary image in image contents.

4. The video camera system of claim 1, wherein the processing unit is a digital circuit comprising a digital signal processor.

5. The video camera system of claim 1, wherein the image processing unit is an image processing chip.

6. The video camera system of claim 1, wherein the first signal line and the second signal line are transmission lines compliant with universal serial bus (USB) protocol.

7. The video camera system of claim 1, wherein the external electronic device is a laptop, tablet, PC or smartphone.
